(19) United States
(12) Patent Application Publication
(10) Pub. No.: US 2016/0374271 A1
(43) Pub. Date: Dec. 29, 2016

(54) ROUND BALER WITH APPARATUS FOR WRAPPING A BALE

(71) Applicant: DEERE & COMPANY, Moline, IL (US)

(72) Inventors: MICHEL MENETRIER, BEAUJEU (FR); JEAN-ALEXIS MERCIER, CHATELPERRON (FR); SEBASTIEN GUERIN, AUDEUX (FR)

(21) Appl. No.: 15/181,574

(22) Filed: Jun. 14, 2016

(30) Foreign Application Priority Data
Jun. 16, 2015 (DE) 102015211000.1

(51) Int. Cl. A01F 15/07; B65B 35/22; B65B 11/04; A01F 15/12; A01F 15/08

(52) U.S. Cl. CPC A01F 15/0715; A01F 15/12; A01F 15/085; B65B 11/04; B65B 35/22; A01F 2015/077

(57) ABSTRACT

A round baler includes a bale-forming chamber, around whose periphery drivable conveying elements are distributed, which can be set in motion by means of a drive train, in order to form a bale from material introduced into the bale-forming chamber, and feeding apparatus that is designed to move wrapping material from a storage reservoir in the direction toward the bale-forming chamber, in order to wrap a bale completed in the bale-forming chamber. A part of the conveying elements can be separated from the drive train during the wrapping process and can be coupled with the feeding apparatus, so that the said part of the conveying elements is driven by the bale to be wrapped during the wrapping process and the feeding apparatus is driven at a speed that is dependent on the respective circumferential speed of the bale.

### CROSS-REFERENCE TO RELATED APPLICATIONS

Pursuant to 35 USC §119, this application claims the benefit of and priority to German patent application no. 102015211000.1, filed on Jun. 16, 2015, which is herein incorporated by reference in its entirety.

### FIELD OF THE DISCLOSURE

This disclosure relates to a round baler and a feeding apparatus for wrapping material.

### BACKGROUND

Round balers are typically equipped with devices that are used for wrapping the completed bales and are set in motion by a drive, and discharge a twine, mesh, or film that is placed around the rotating bales and envelopes them. Such devices must be activated after the completion of the bale, which takes place in the prior art at the request of the operator by means of an input device after it has been signaled to him by a display device that the bale size detected by means of a suitable sensor has reached a certain value. It was also proposed to automatically activate the drive of the arrangement for wrapping the bale as soon as the sensor for detecting the bale size indicates that the desired bale diameter will soon be reached (DE 10 2009 002 439 A1).

The wrapping material is fed in the direction toward the baler chamber by rollers, between which the wrapping material is guided. In terms of driving, these rollers are coupled in the prior art with the drive of the bale-forming means that involve belts or rollers that are distributed around the periphery of the bale-forming chamber. The rollers feed the wrapping material somewhat more slowly than the circumferential speed of the bale into the bale-forming chamber until the wrapping material is gripped by the bale. Then the bale pulls the wrapping material from a storage reservoir and a free-wheel disconnects the rollers from their drive.

As long as the speed of the bale matches the speed of the bale-forming means, i.e., there is no slip, the wrapping material is carried along without a problem by the bale. If, however, there is slip between the bale and the bale-forming means, which is possible, for example, in the event of moist harvested produce, such as silage, so that the circumferential speed of the bale is less than that of the bale-forming means, the feeding speed of the wrapping material is also greater than the circumferential speed of the bale. This leads to loops being formed in the wrapping material, non-optimal wrapping of the bale, and in the worst case, the wrapping material wraps around a roller of the bale-forming chamber and must be removed by the operator.

### SUMMARY

The present disclosure provides a round baler and a feeding apparatus which prevents or at least improves the disadvantages mentioned above.

A round baler includes a bale-forming chamber around whose periphery drivable conveying elements are distributed that can be set in motion by a drive train, in order to form material introduced into the bale-forming chamber into a bale, and feeding apparatus that are designed to move wrapping material from storage in the direction toward the bale-forming chamber, in order to wrap a bale completed in the bale-forming chamber. A part of the conveying elements can be disconnected from the drive train during the wrapping process and can be coupled with the feeding apparatus.

In this way, it is achieved that the said part of the conveying elements is driven during the wrapping process by the bale to be wrapped and drives the feeding apparatus at a speed that is dependent on the respective circumferential speed of the bale. Thus, the feeding speed of the wrapping material depends directly on the circumferential speed of the bale, and the disadvantages present in the prior art are avoided.

### BRIEF DESCRIPTION OF THE DRAWINGS

In the drawings, an embodiment of the disclosure described in more detail below is shown, wherein the reference symbols should not be used to limit the scope of the disclosure. Shown are:

FIG. 1 a round baler with a device for wrapping a bale and a tractor in a side view and in schematic representation, and

FIG. 2 a schematic representation of the drive of the round baler of FIG. 1.

### DETAILED DESCRIPTION

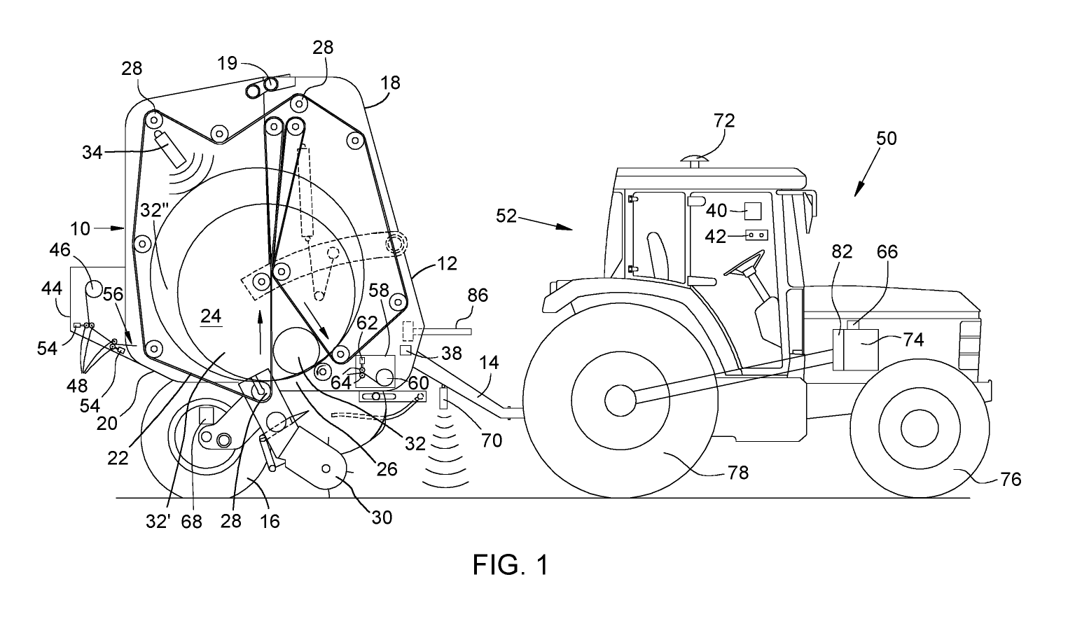

FIG. 1 shows a round baler 10 with a housing 12 that can be attached by means of a tow bar 14 to a coupling eye of a tractor 50 in the form of a general-purpose farm tractor, in order to be pulled across a field in a driving direction toward the right with respect to FIG. 1, and can be supported on wheels 16. The housing 12 is composed from a front, rigid housing half 18 and a rear, pivoting housing half 20 that are connected to each other in an upper joint 19 so that they can pivot. The housing 12 carries a plurality of rollers 28. Over the rollers 28 run several endless conveying elements 22 that are arranged one next to the other and for the most part surround a bale-forming chamber 24 together with side walls of the housing 12. In this embodiment, the conveying elements 22 are formed for the most part as belts, wherein, however, a conveying element 22′ is also constructed as a roller 36. In the lower area of the bale-forming chamber 24 there is an inlet 26 that is bounded at the rear by a roller 28 and that allows material picked up by a pick-up device 30 to be fed into the bale-forming chamber 24. The roller 36 is located above and in front of the inlet 26.

The round baler 10 includes several conveying elements 22 arranged laterally one next to the other. They are set in motion during harvesting operation and surround a bale 32 forming in the bale-forming chamber 24 on the front, top, and rear sides. The configuration and function of such a round baler are known. Reference is made to the disclosure of DE 101 53 540 A, the content of which is incorporated into the present document through this reference. With the reference symbols 32, 32′, and 32″, bales of increasing diameters are marked.

A sensor 34 is mounted on the rear, upper end of the rear, pivoting housing half 20. The sensor 34 is an ultrasonic range sensor that involves a propagation time measurement and detects the distance between its bottom side and the adjacent conveying apparatus 22 that directly contact the outer periphery of the bale 32. In this way, the sensor 34 provides information on the diameter of the bale 32.

The round baler 10 also includes a first wrapping material dispenser 44 that is arranged on the rear side of the rear, pivoting housing half 20. The wrapping material dispenser 44 includes a storage reservoir 46 of wrapping material that consists of a rolled-up mesh or film, whose front, unwound end is guided between pairs of rollers 48 acting as feeding apparatus. The rollers 48 can be set in rotation by a drive 54, so that when the drive 54 is activated, the front end of the wrapping material is pulled by the conveying apparatus 22 into the bale-forming chamber 24 and wraps around the bale 32. Between the drive 54 and the rollers 48 there is a free-wheel (not shown), so that the bale 32 can pull the wrapping material from the storage reservoir 46 for unwrapping without the drive 54 also turning. In addition, the first wrapping material dispenser 44 includes a separating device 56, in order to cut the wrapping material after the wrapping process.

A second wrapping material dispenser 58 is located on the front side of the round baler 10 and includes a storage reservoir 60 of wrapping material consisting of twine. The second wrapping material dispenser 58 also includes a pair of rollers 64 that act as feeding apparatus and that can be driven by means of a drive 62 in order to introduce the front end of the wrapping material into the bale-forming chamber 24, so that it is carried along by the bale 32 and wraps around the bale. The wrapping material is fed successively across the width of the bale 32, in that the entire wrapping material dispenser 58 or an outlet opening is moved continuously to the side. Between the drive 62 and the rollers 64 there is a free-wheel (not shown), so that the bale 32 can pull the wrapping material out from the storage reservoir 60 for unwrapping without the drive 62 also turning. In addition, the first wrapping material dispenser 44 includes a separating device (not shown), in order to cut the wrapping material after the wrapping process.

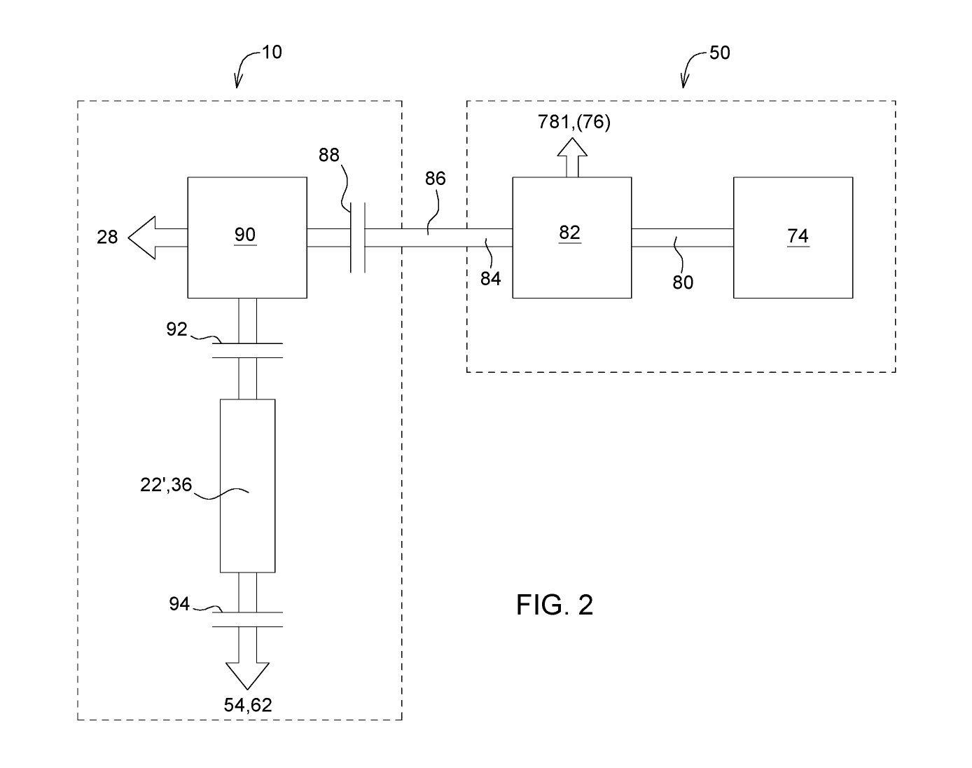

By means of a bus line, the sensor 34 is connected to a controller 38 that in turn controls a display device 40 arranged in the driver's cabin 52 of the tractor 50 and receives instructions from an input device 42 also arranged there. The controller 38 is also coupled with actuators for actuating couplings 88, 92, and 94 (cf. FIG. 2), a speed setting device (engine and transmission controller) 66 of the tractor 50, a speed sensor 68 in the form of an rpm sensor for detecting the revolutions per minute of the wheels 16, a throughput sensor 70 that is mounted on the bottom side of the tow bar 14 and that uses optical or ultrasonic wave apparatus to sample the swath to be picked up by the pick-up device 30, in order to determine its volume, and a position determining device 72. The controller 38 can operate, in particular, in the way described in DE 10 2009 002 439 A1, the disclosure of which is incorporated into the present document through this reference, in order to detect when it is time to wrap a bale.

FIG. 2 shows the drive train of the round baler 10 schematically. The crankshaft 80 of the internal combustion engine 74 is coupled with a transmission 82 that drives, on one hand, a drive train to the drivable rear wheels 78 of the tractor 50 (and optionally to the steerable front wheels 76), on the other hand, also a power-take-off output 84 that drives the moving elements of the round baler 10 by a drive shaft 86. On the side of the round baler 10, the drive shaft 86 drives, by means of a first coupling 88, a transfer gearbox 90 that in turn drives one or more of the rollers 28 that in turn drive the conveying elements 22. An output of the transfer gearbox 90 is connected via a second coupling 92 to the roller 36. The roller 36 can be coupled via a third coupling 94 with the drives 54 and/or 62. The coupling 88 could also be replaced or expanded by a power-take-off coupling (not shown) of the tractor 50, which takes over the function of the coupling 88.

Below, only the operation of the round baler 10 is described.

In normal bale-forming operation, at the input of the operator via the input device 42, the controller 38 causes the first coupling 88 and the second coupling 92 to become closed. The third coupling 94 is open. The conveying apparatus 22, 22′ thus move, and material (harvested produce) coming in through the inlet 26 is gradually formed into a bale 32 of continuously increasing diameter, while the tractor 50 pulls the round baler 10 along a swath and the pick-up device 30 feeds the harvested produce into the inlet 26.

At a manual input of the operator into the input device 42 or when the controller 38 detects that a preset size of the bale 32 has been reached, the controller 38 indicates to the operator by means of the display device 40 that a wrapping process will now take place and he should stop the tractor 50. The stopping of the tractor can also take place automatically by the controller 38 by means of the speed adjusting device 66. The controller 38 now causes the first coupling 88 to remain closed; the second coupling 92 is opened, and the third coupling 94 is closed. In this way, one of the drives 54 or 62 is set in motion in order to feed the wrapping material from the storage reservoir 46 or 60 into the bale-forming chamber 24, while the bale 32 continues to be driven by the conveying apparatus 22, but no longer by the roller 36 of the conveying apparatus 22′. By means of the mechanically actuated couplings, not shown in FIG. 2, the operator can select which of the drives 54 or 62 is activated. In an advanced embodiment, this selection can be realized via the input device 42 and the controller 38, which can control the corresponding couplings electromechanically or electrohydraulically, in order to select the wrapping material.

According to all of this, the drive of the roller 48 or 64 is realized by means of the roller 36 (separated by the second coupling 92 from its drive train driving the bale-forming), which is driven on its side by friction by the bale 32, mechanically by means of the third coupling 94 and the drives 54 or 62. In this way, it is guaranteed that the feeding apparatus is driven at exactly the circumferential speed of the bale 32 (or slower by a defined percentage), so that even if the bale 32 should slip relative to the conveying apparatus 22, the wrapping material is not introduced faster than the bale 32 rotates. In this way, undesired loop formations in the wrapping material are avoided and this prevents the wrapping material, e.g., from winding around the roller 36.

After the bale 32 has been completely wrapped, the first and third coupling 88, 94 are disconnected and the bale 32 is ejected from the round baler 10 after opening the rear, pivoting housing half 20. Then a new bale 32 can be formed.

It remains to be noted that the round baler could also be constructed as a fixed chamber baler in a different embodiment, in which a number of rollers is distributed around the periphery of the bale-forming chamber. One of these rollers then corresponds to the roller 36 of the embodiment shown here. It would also be conceivable, instead of the rear, pivoting housing half 20, to just pivot a carrier upward, which carries a few of the rollers 28, cf. EP 1 795 065 A1 and the references cited therein, or to mount a few rollers interacting directly with the harvested produce on a moving carrier, cf. DE 10 2009 002 585 A1. The couplings 92, 94 do not have to be constructed as plate couplings, as shown in FIG. 2, but instead could be constructed as belt couplings. The latter could also be mounted on the same side of the roller 36 and could be alternately actuated, in particular, by a single actuator.

1. A round baler, comprising:
a bale-forming chamber, around whose periphery drivable conveying elements are distributed, which can be set into motion by a drive train, in order to form a bale from material introduced into the bale-forming chamber, and
feeding apparatus that are designed to move wrapping material from a storage reservoir in the direction toward the bale-forming chamber, in order to wrap a bale completed in the bale-forming chamber,
wherein a part of the conveying elements can be disconnected from the drive train during the wrapping process and can be coupled with the feeding apparatus, so that the said part of the conveying elements is driven by the bale to be wrapped during the wrapping process and the feeding apparatus is driven at a speed that is dependent on the respective circumferential speed of the bale.

2. The round baler of claim 1, wherein the part of the conveying elements is a roller.

3. The round baler of claim 1, wherein the wrapping material is a mesh, twine, or film.
